(19) United States
(12) Patent Application Publication
(10) Pub. No.: US 2009/0006247 A1
(43) Pub. Date: Jan. 1, 2009

(54) Services for Billing and Management of Consumable Resources

(75) Inventors: Johan Peter Hansen, Redmond, WA (US); Shyam Krishnamoorthy, Kirkland, WA (US); Ling Tony Chen, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/771,277

(22) Filed: Jun. 29, 2007

(51) Int. Cl. G06Q 30/00; G06F 17/30

(52) U.S. Cl. 705/39; 707/104.1

(57) ABSTRACT

Provided are systems and services for billing and managing on-demand access to consumable goods and services. The system allows a user to consume resources via an application on a computing device by connecting to a service and requesting access to the resource based on a stored balance associated with a user ID and resource ID. If it is determined by the service that the user has the rights to access the resource, then access to the resource may be granted via the application. If it is determined by the service that the user does not have the rights to access a resource, a right to access the resource may be purchased from the service.

### TECHNOLOGY FIELD

The present invention generally relates to systems and services for billing and managing consumable resources. More particularly, the present invention may be implemented to bill and manage consumable resources related to a computing application on a trusted client connected to a service.

### BACKGROUND

Content and services, such as video and audio recordings, streaming broadcasts, and other multi-media presentations, are increasingly being provided to consumers in digital form. Widespread use of the Internet is significantly fueling the expanding dissemination of digital content and services. Given the availability of relatively inexpensive but rather sophisticated personal computing devices, the Internet is emerging as an excellent vehicle through which digital content and services can be provided. This content can range from audio or video clips, to recorded songs to entire movies. As a result, services such as Xbox® Live® Marketplace® are becoming increasingly popular.

Traditionally, there have been two prevalent licensing models for providing goods and services to users—a permanent access model and a recurring subscription model. In a permanent access licensing model, a user makes a one time purchase and is granted permanent access to a good or service. In a recurring subscription model, a user makes recurring payments for continued access to goods and services. There are currently no licensing models or implementations that allow a user deferred, on-demand access to consumable goods and services. In other words, under existing licensing models and implementations, a user cannot purchase a bundle of consumable goods or services and have those goods and services available for consumption on demand at a later unspecified time.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

The present application is directed to providing systems and services for billing and managing on-demand access to consumable goods and services. In an exemplary implementation, a user can access the consumable resources via an application on a computing device connected to the network. The user can further elect to consume or purchase the resources.

When a user elects to consume a resource, a request is sent to a service server via an API layer, identifying a user ID, a resource ID, and the quantity of the resource. The API layer processes the request and the service server determines whether the requested quantity of the resource ID is available on a balance associated with the user ID. If the requested quantity of the resource ID is not available on a balance associated with the user ID, then access to the requested resource is denied to the user in the application via the API layer. If the requested quantity of the resource ID is available on a balance associated with the user ID, then access to the requested resource is granted to the user in the application via the API layer. When access to the resource is granted and the resource is consumed, a message identifying the user ID, resources ID, and the quantity consumed is sent to the service server via the API layer. The service server then subtracts the consumed quantity of the resource ID from the balance associated with the user ID.

When a user elects to purchase a resource, a request is sent to a service server via an API layer, identifying a user ID and a resource ID. In response, the service server sends the application via the API layer a sale offer identifying the user ID, a resource ID, a predetermined quantity of the resource, and a price. If the user accepts the sale offer, a message is sent to the API layer to the process the purchase transaction. Once the purchase transaction is processed and payment is received, the API layer sends a message to the service server identifying a user ID, a resource ID, and a quantity purchased. The service server then adds the purchased quantity of the resource ID to the balance associated with the user ID. Thus, consumption of the purchased quantity of the resource can be deferred and made on demand as described above.

According to another aspect of the invention, the API layer comprises at least three API modules: a check API module, a purchase API module, and a consume API module. The check API module processes requests for the service server to checks its database and determine whether the quantity of a resource ID is available in a balance associated with the user ID. The purchase API module processes requests to purchase a resource, sale offers for resources, and settlement of purchases of resources. The consume API module processes messages regarding the consumption of resources to update the balance of a resource ID associated with a user ID in the service server.

Additional features and advantages will be made apparent from the following detailed description of illustrative embodiments that proceeds with reference to the accompanying drawings.

### BRIEF DESCRIPTION OF THE DRAWINGS

The foregoing summary, as well as the following detailed description, is better understood when read in conjunction with the appended drawings. For the purpose of illustrating services for billing and managing consumable resources, there is shown in the drawings exemplary constructions thereof; however, billing and management of consumable resources is not limited to the specific methods and instrumentalities disclosed.

FIG. 1 is a perspective view of an exemplary gaming and media system.

FIG. 2 is a functional block diagram of a console used in a gaming and media system like that shown in FIG. 1.

FIG. 3 is a functional block diagram of an exemplary computing device or system.

FIG. 4 is a functional block diagram of an exemplary operating environment for a system for delivering services for billing and managing consumable resources.

FIG. 5 is a flow diagram illustrating the steps of an exemplary method billing and managing consumable resources.

### DETAILED DESCRIPTION OF ILLUSTRATIVE EMBODIMENTS

Exemplary embodiments are illustrated in referenced Figures of the drawings. It is intended that the embodiments and Figures disclosed herein are to be considered illustrative rather than restrictive.

### Exemplary Gaming and Media System

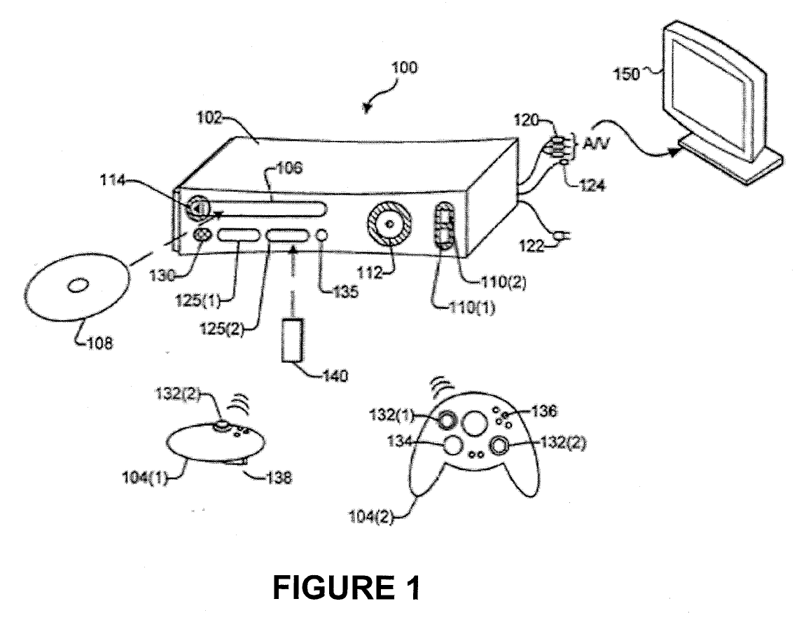

FIG. 1 shows an exemplary gaming and media system 100. The following discussion of this Figure is intended to provide a brief, general description of a suitable computing device or system via which certain methods may be implemented. As shown in FIG. 1, gaming and media system 100 includes a game and media console (hereinafter simply “console”) 102. In general console 102 is one type of computing device or system, as further described below, and is exemplary of a computing device or system that can be used in connection with a service for billing and managing consumable resources, but is not intended to be limiting. Console 102 is configured to accommodate one or more wireless controllers, as represented by controllers 104(1) and 104(2). Further, console 102 is equipped with an internal hard disk drive (not shown), and a portable media drive 106 that supports various forms of portable storage media, as represented by optical storage disc 108. Examples of suitable portable storage media include DVD, CD-ROM, game discs, and so forth. Console 102 also includes two memory unit card receptacles 125(1) and 125(2), for receiving removable flash-type memory units 140. A command button 135 on console 102 enables and disables wireless peripheral support.

As depicted in FIG. 1, console 102 also includes an optical port 130 for communicating wirelessly with one or more devices and two Universal Serial Bus (USB) ports 110(1) and 110(2) to support a wired connection for additional controllers, or other peripherals. In some implementations, the number and arrangement of additional ports may be modified. A power button 112 and an eject button 114 are also positioned on the front face of game console 102. Power button 112 is selected to apply power to the game console, and can also provide access to other features and controls, and eject button 114 alternately opens and closes the tray of a portable media drive 106 to enable insertion and extraction of a storage disc 108.

Console 102 connects to a television or other display via A/V interfacing cables 120. In one implementation, console 102 is equipped with a dedicated A/V port (not shown) configured for content-secured digital communication using A/V cables 120 (e.g., A/V cables suitable for coupling to a High Definition Multimedia Interface “HDMI” port on a high definition monitor 150 or other display device). A power cable 122 provides power to the game console. Console 102 may be further configured with broadband capabilities, as represented by a cable or modem connector 124 to facilitate access to a network, such as the Internet.

Each controller 104 is coupled to console 102 via a wired or wireless interface. In the illustrated implementation, the controllers are USB-compatible and are coupled to console 102 via a wireless or USB port 110. Console 102 may be equipped with any of a wide variety of user interaction mechanisms. In an example illustrated in FIG. 1, each controller 104 is equipped with two thumbsticks 132(1) and 132(2), a D-pad 134, buttons 136, and two triggers 138. These controllers are merely representative, and other known gaming controllers may be substituted for, or added to, those shown in FIG. 1.

In one implementation (not shown), a memory unit (140 may also be inserted into controller 104 to provide additional and portable storage. Portable MUs enable users to store game parameters for use when playing on other consoles. In this implementation, each controller is configured to accommodate two MUs 140, although more or less than two MUs may also be employed.

Gaming and media system 100 is generally configured for playing games and other electronic content stored on a memory medium (e.g. internal and/or portable), shopping for and purchasing products such as electronic media including game and game component downloads, and reproducing pre-recorded music and videos, from both electronic and hard media sources. With the different storage offerings, titles can be played from the hard disk drive, from optical disk media (e.g., 108), from an online source, or from MU 140. A sample of some of the types of media that gaming and media system 100 is capable of playing include: game titles played from CD and DVD discs, from the hard disk drive, or from an online source. Digital music played from a CD in portable media drive 106, from a file on the hard disk drive (e.g., music in the Windows Media Audio (WMA) format), or from online streaming sources. Digital audio/video played from a DVD disc in portable media drive 106, from a file on the hard disk drive (e.g., Active Streaming Format), or from online streaming sources.

### Functional Details of Exemplary Game Console

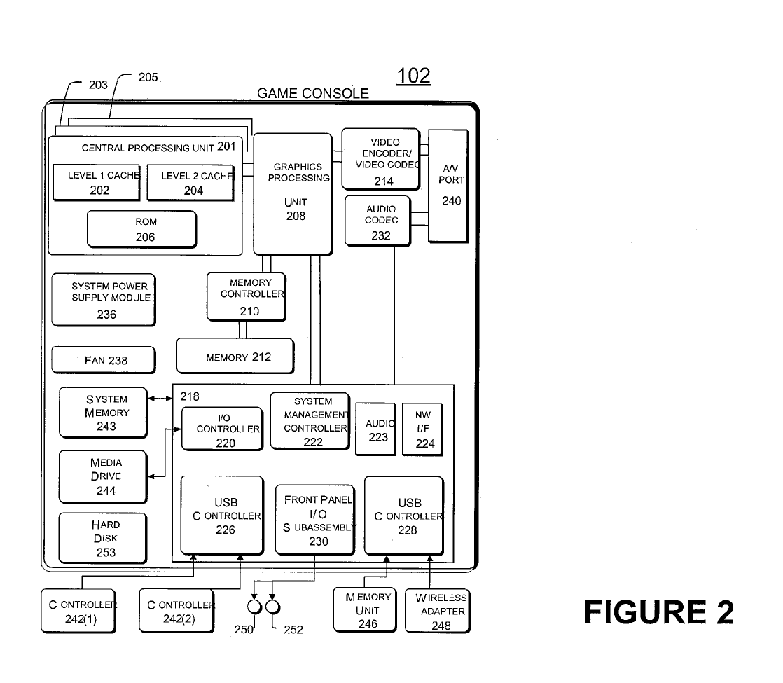

FIG. 2 is a functional block diagram showing details of an example gaming and media system 100 via which services for billing and managing consumable resources can be implemented. The game console 102 along with other devices described herein, such as a display device, are capable of performing the functions needed to accomplish billing and management of consumable resources. A typical game console comprises hardware and software that are specifically designed to support a core set of usage scenarios.

Game console 102 has a central processing unit (CPU) 201 having a level 1 (L1) cache 202, a level 2 (L2) cache 204, and a flash ROM (Read-only Memory) 206. The level 1 cache 202 and level 2 cache 204 temporarily store data and hence reduce the number of memory access cycles, thereby improving processing speed and throughput. The flash ROM 206 can store executable code that is loaded during an initial phase of a boot process when the game console 102 is initially powered. Alternatively, the executable code that is loaded during the initial boot phase can be stored in a FLASH memory device (not shown). Further, ROM 206 can be located separate from CPU 201. Game console 102 can, optionally, be a multi-processor system; for example game console 102 can have three processors 201, 203, and 205, where processors 203 and 205 have similar or identical components to processor 201.

A graphics processing unit (GPU) 208 and a video encoder/video codec (coder/decoder) 214 form a video processing pipeline for high speed and high resolution graphics processing. Data is carried from the graphics processing unit 208 to the video encoder/video codec 214 via a bus. The video processing pipeline outputs data to an A/V (audio/video) port 240 for transmission to a television or other display device. A memory controller 210 is connected to the GPU 208 and CPU 201 to facilitate processor access to various types of memory 212, such as, but not limited to, a RAM (Random Access Memory).

Game console 102 includes an I/O controller 220, a system management controller 222, an audio processing unit 223, a network interface controller 224, a first USB host controller 226, a second USB controller 228 and a front panel I/O subassembly 230 that may be implemented on a module 218. The USB controllers 226 and 228 serve as hosts for peripheral controllers 242(1)-842(2), a wireless adapter 248, and an external memory unit 246 (e.g., flash memory, external CD/DVD ROM drive, removable media, etc.). The network interface 224 and/or wireless adapter 248 provide access to a network (e.g., the Internet, home network, etc.) and may be any of a wide variety of various wired or wireless interface components including an Ethernet card, a modem, a Bluetooth module, a cable modem, and the like.

System memory 243 is provided to store application data that is loaded during the boot process. A media drive 244 is provided and may comprise a DVD/CD drive, hard drive, or other removable media drive, etc. The media drive 244 may be internal or external to the game console 102. When media drive 244 is a drive or reader for removable media (such as removable optical disks, or flash cartridges), then media drive 244 is an example of an interface onto which (or into which) media are mountable for reading. Application data may be accessed via the media drive 244 for execution, playback, etc. by game console 102. Media drive 244 is connected to the I/O controller 220 via a bus, such as a Serial ATA bus or other high speed connection (e.g., IEEE 5394). While media drive 244 may generally refer to various storage embodiments (e.g., hard disk, removable optical disk drive, etc.), game console 102 may specifically include a hard disk 252, which can be used to store game data, application data, or other types of data.

The system management controller 222 provides a variety of service functions related to assuring availability of the game console 102. The audio processing unit 223 and an audio codec 232 form a corresponding audio processing pipeline with high fidelity, 5D, surround, and stereo audio processing according to aspects of the present subject matter described herein. Audio data is carried between the audio processing unit 223 and the audio codec 226 via a communication link. The audio processing pipeline outputs data to the A/V port 240 for reproduction by an external audio player or device having audio capabilities.

The front panel I/O subassembly 230 supports the functionality of the power button 250 and the eject button 252, as well as any LEDs (light emitting diodes) or other indicators exposed on the outer surface of the game console 102. A system power supply module 236 provides power to the components of the game console 102. A fan 238 cools the circuitry within the game console 102.

The CPU 201, GPU 208, memory controller 210, and various other components within the game console 102 are interconnected via one or more buses, including serial and parallel buses, a memory bus, a peripheral bus, and a processor or local bus using any of a variety of bus architectures.

When the game console 102 is powered on or rebooted, application data can be loaded from the system memory 243 into memory 212 and/or caches 202, 204 and executed on the CPU 201. The application can present a graphical user interface that provides a consistent user experience when navigating to different media types available on the game console 102. In operation, applications and/or other media contained within the media drive 244 may be launched or played from the media drive 244 to provide additional functionalities to the game console 102.

The game console 102 may be operated as a standalone system by simply connecting the system to a television or other display. In this standalone mode, the game console 102 may allow one or more users to interact with the system, watch movies, listen to music, and the like. However, with the integration of broadband connectivity made available through the network interface 224 or the wireless adapter 248, the game console 102 may further be operated as a participant in a larger network community.

### Exemplary Computing System

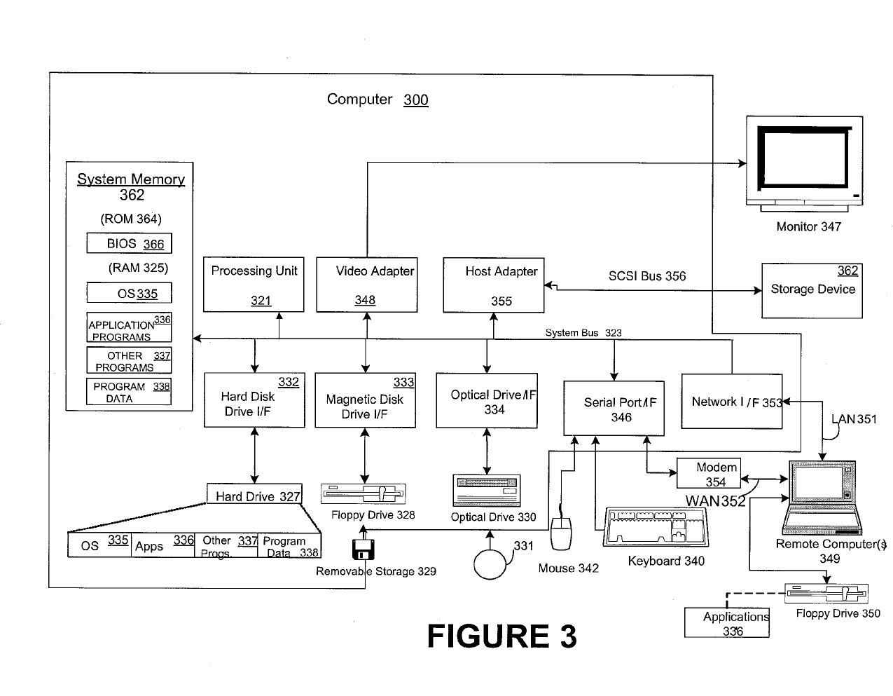

The following discussion of FIG. 3 is intended to provide a brief, general description of another suitable computing device or system via which certain methods may be implemented. Moreover, implementation of services for billing and managing consumable resources can be practiced with other computer system configurations, including hand held devices, multi processor systems, microprocessor based or programmable consumer electronics, network PCs, minicomputers, mainframe computers, and the like. FIG. 3 shows one type of computing device or system, as further described below, and is exemplary of a computing device that can be used in connection with a service for billing and managing consumable resources, but is not intended to be limiting.

According to another aspect of the invention, a computer server as shown in FIG. 3 may be used to provide services for billing and managing of consumable resources to trusted clients. Trusted clients may be gaming and media systems 100 or similar computing devices that have software to ensure communication with a user to whom access to a service is authorized. In one or more embodiments, it should be emphasized that only users with specific computing devices or computing devices equipped with specific software may be able to benefit from the service provided by the exemplary computer server shown in FIG. 3, since access to the service may be restricted.

Although not required, various aspects of the services for billing and managing consumable resources can be described in the general context of computer executable instructions, such as program modules, being executed by a computer, such as a client workstation or a server. Generally, program modules include routines, programs, objects, components, data structures and the like that perform particular tasks or implement particular abstract data types. Further, services for billing and managing consumable resources also can be practiced in distributed computing systems where tasks are performed by remote processing devices that are linked through a communications network. In a distributed computing system, program modules can be located in both local and remote memory storage devices.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 321, the memory (both ROM 364 and RAM 325), the basic input/output system (BIOS) 366, and various input/output (I/O) devices such as a keyboard 340, a mouse 362, a monitor 347, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users). In an example embodiment, application programs perform the functions associated with services for billing and managing consumable resources as described above.

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. A purpose of a hardware/software interface system is to provide an system in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

As shown in FIG. 3, an exemplary general purpose computing system includes a conventional computing device 300 or the like, including a processing unit 321, a system memory 362, and a system bus 323 that couples various system components including the system memory to the processing unit 321. The system bus 323 may be any of several types of bus structures including a memory bus or memory controller, a peripheral bus, and a local bus using any of a variety of bus architectures. The system memory includes read only memory (ROM) 364 and random access memory (RAM) 325. A basic input/output system 366 (BIOS), containing basic routines that help to transfer information between elements within the computing device 300, such as during start up, is stored in ROM 364. The computing device 300 may further include a hard disk drive 327 for reading from and writing to a hard disk (hard disk not shown), a magnetic disk drive 328 (e.g., floppy drive) for reading from or writing to a removable magnetic disk 329 (e.g., floppy disk, removal storage), and an optical disk drive 330 for reading from or writing to a removable optical disk 331 such as a CD ROM or other optical media. The hard disk drive 327, magnetic disk drive 328, and optical disk drive 330 are connected to the system bus 323 by a hard disk drive interface 332, a magnetic disk drive interface 333, and an optical drive interface 334, respectively. The drives and their associated computer readable media provide non volatile storage of computer readable instructions, data structures, program modules and other data for the computing device 300. Although the exemplary system described herein employs a hard disk, a removable magnetic disk 329, and a removable optical disk 331, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like may also be used in the exemplary computing system. Likewise, the exemplary system may also include many types of monitoring devices such as heat sensors and security or fire alarm systems, and other sources of information.

A number of program modules can be stored on the hard disk, magnetic disk 329, optical disk 331, ROM 364, or RAM 325, including an operating system 335, one or more application programs 336, other program modules 337, and program data 338. A user may enter commands and information into the computing device 300 through input devices such as a keyboard 340 and pointing device 362 (e.g., mouse). Other input devices (not shown) may include a microphone, joystick, game pad, satellite disk, scanner, or the like. These and other input devices are often connected to the processing unit 321 through a serial port interface 346 that is coupled to the system bus, but may be connected by other interfaces, such as a parallel port, game port, or universal serial bus (USB). A monitor 347 or other type of display device is also connected to the system bus 323 via an interface, such as a video adapter 348. In addition to the monitor 347, computing devices typically include other peripheral output devices (not shown), such as speakers and printers. The exemplary system of FIG. 3 also includes a host adapter 355, Small Computer System Interface (SCSI) bus 356, and an external storage device 362 connected to the SCSI bus 356.

The computing device 300 may operate in a networked environment using logical connections to one or more remote computers, such as a remote computer 349. The remote computer 349 may be another computing device (e.g., personal computer), a server, a router, a network PC, a peer device, or other common network node, and typically includes many or all of the elements described above relative to the computing device 300, although only a memory storage device 350 (floppy drive) has been illustrated in FIG. 3. The logical connections depicted in FIG. 3 include a local area network (LAN) 351 and a wide area network (WAN) 352. Such networking environments are commonplace in offices, enterprise wide computer networks, intranets and the Internet.

When used in a LAN networking environment, the computing device 300 is connected to the LAN 351 through a network interface or adapter 353. When used in a WAN networking environment, the computing device 300 can include a modem 354 or other means for establishing communications over the wide area network 352, such as the Internet. The modem 354, which may be internal or external, is connected to the system bus 323 via the serial port interface 346. In a networked environment, program modules depicted relative to the computing device 300, or portions thereof, may be stored in the remote memory storage device. It will be appreciated that the network connections shown are exemplary and other means of establishing a communications link between the computers may be used.

While it is envisioned that numerous embodiments of services for billing and managing consumable resources are particularly well-suited for computerized systems, nothing in this document is intended to limit the invention to such embodiments. On the contrary, as used herein the term “computing device or system” is intended to encompass any and all devices capable of storing and processing information and/or capable of using the stored information to control the behavior or execution of the device itself, regardless of whether such devices are electronic, mechanical, logical, or virtual in nature.

The various techniques described herein can be implemented in connection with hardware or software or, where appropriate, with a combination of both. Thus, the methods and apparatuses for implementing services for billing and managing consumable resources, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for implementing services for billing and managing consumable resources.

The program(s) can be implemented in assembly or machine language, if desired. In any case, the language can be a compiled or interpreted language, and combined with hardware implementations. The methods and apparatuses for implementing services for billing and managing consumable resources also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like. When implemented on a general-purpose processor, the program code combines with the processor to provide a unique apparatus that operates to invoke the functionality of billing and managing consumable resources. Additionally, any storage techniques used in connection with services for billing and managing consumable resources can invariably be a combination of hardware and software.

While services for billing and managing consumable resources may be described in connection with the example embodiments of the various Figures, it is to be understood that other similar embodiments can be used or modifications and additions can be made to the described embodiments for performing the same functions of billing and managing consumable resources without deviating therefrom. Therefore, services for billing and managing consumable resources as described herein should not be limited to any single embodiment, but rather should be construed in breadth and scope in accordance with the appended claims.

### Exemplary Operating Environment

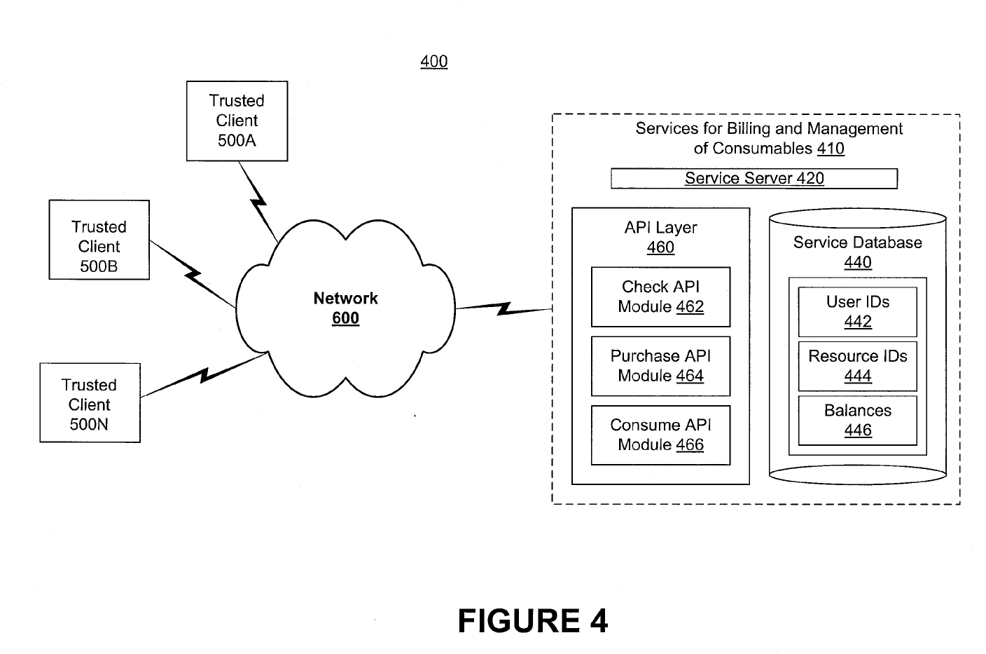

FIG. 4 is a block diagram of an exemplary operating environment 400 for various methods and systems for services directed to billing and managing consumable resources. FIG. 4 shows a service for billing and managing consumable resources 410 (hereinafter simply “service”) in communication with a plurality of trusted clients 500A-500N via communication system 600. Service 410 further includes one or more server computing systems 420 (although only one shown), an API layer 430, and a service database 440. As shown in FIG. 4, API layer 430 comprises at least three API modules: a check API module 432, a purchase API module 434, and a consume API module 436. Service database 440 is shown as including a user ID table 442, a resource ID table 444, and a balance table 446.

In one implementation, each of the plurality of trusted clients 500A-500N may be one of: a gaming and media system 100 or a computing device or system 300 as described above that have software to ensure communication with a user to whom access to a service is authorized . . . In general, however, trusted clients 500A-500N can include hand held devices, microprocessor based or programmable consumer electronics, network PCs, or minicomputers that are enabled for communication with service 410. In one or more implementations, the trusted clients 500A-500N are configured to enable transactions with service 410 using a credit card, a prepaid card, or an electronic user account (e.g., a micro-point balance account).

In an on-line mode, a trusted client 500 can be configured to request, automatically or based on a user action, various information from the service 410. Additionally, the service 410 can be configured to push information to a trusted client 500, periodically or as discrete events, based on various data provided from the electronic device 500. Service 410 can also be configured to provide various user dialog screens for enabling a user to interact with the service to facilitate different functions, such as billing and managing consumable resources.

Communication system 600 can be any communication system configured to communicate signals between trusted clients 500A-500N and service 410. In one implementation, communication system 600 is implemented with calls to dedicated application program interfaces (APIs) using a secure communication protocol that enables closed-network communication between the trusted clients 500A-500N and service 410. Communication system 600 thus excludes other computing devices generally from communicating with service 410, so that only trusted clients 500A-500N are able to enjoy the benefit of the service.

In general, service 410 is any combination of one or more server-side computing devices and applications or modules configured to deliver billing and managing services to trusted clients 500. In one implementation, service 410 includes a server 420 having a service database 440 and an API layer 460 connected to a network 600. In another implementation, service database 440 and the API layer 460 may be components of a so-called “server farm” comprising a plurality of servers or server computing systems. Further, service 410 can include additional components or modules that are not relevant to the present discussion, and which are therefore omitted from FIG. 4 for clarity.

Service database 440 may include one or more relational databases stored in one or more data storage devices (not separately shown in FIG. 4) at one or more locations. In one implementation, service database 440 is a distributed data storage system that includes one or more databases located in one or more locations, which can be in communication via a communication system (not shown). In one embodiment, service database 440 includes a plurality of data records, including user records 442, user records 444, and balance records 446. User records 442 can include a variety of information related to each user, such as an associated unique identification code or key for each user (hereinafter simply “user ID 443”).

User records 444 can include a variety of information related to application-specific resources, such as a unique identification code or key (hereinafter simply “resource ID 445”) for each type of resource. Further, the user records 442 may associate each resource ID 445 with an identification code or key (hereinafter simply “application ID 447”) for a specific application and a price 448 for a specified quantity of the resource ID 445. The price for a specified quantity of a resource ID 445 may be expressed in terms of real or virtual currency. Application-specific resources may be virtual or tangible goods and/or services that may be consumed in connection with a particular application. In one implementation, application-specific resources may be a bundle of rights that grant permission to access a virtual good or service from a server on demand, or access a virtual good or service from a local computing application on demand. For example, virtual goods may include digital game components or digital media, and virtual services may include online gaming tournaments or program broadcasts. In another implementation, application-specific resources may be rights in tangible goods and/or services, e.g., when a tangible good is purchased via a computing device and a postal fulfillment for the good is pending.

Balance records 446 associate information related to a specific user ID 443 with information related to a resource ID 445 available to the user ID 443. Each balance record 446 can also include history associated with a specific user ID 443 that can incorporate a record of each resource ID 445 accessed, purchased, acquired, or viewed, a tally of purchased electronic payment units, and other information tied to a specific user ID 443.

API layer 460 handles requests made by an application on a trusted client 500 to the service 410. The API layer 460 includes a check API module 462, a purchase API module 464, and a consume API module 466. The check API module 462 is configured to communicate messages between an application on a trusted client 500 and service 410 regarding the availability of a resource ID 445 to a user ID 443. The purchase API module 464 is configured to communicate messages between an application on a trusted client 500 and service 410 regarding the purchase of a resource ID 445 by a user ID 443. The consume API module 466 is configured to communicate messages between an application on a trusted client 500 and service 410 regarding the consumption of a resource ID 445 by a user ID 443. Thus, each API module is dedicated to handle specific types of requests from an application on a trusted client 500 to service 410.

### Exemplary Methods for Billing and Managing Consumable Resources

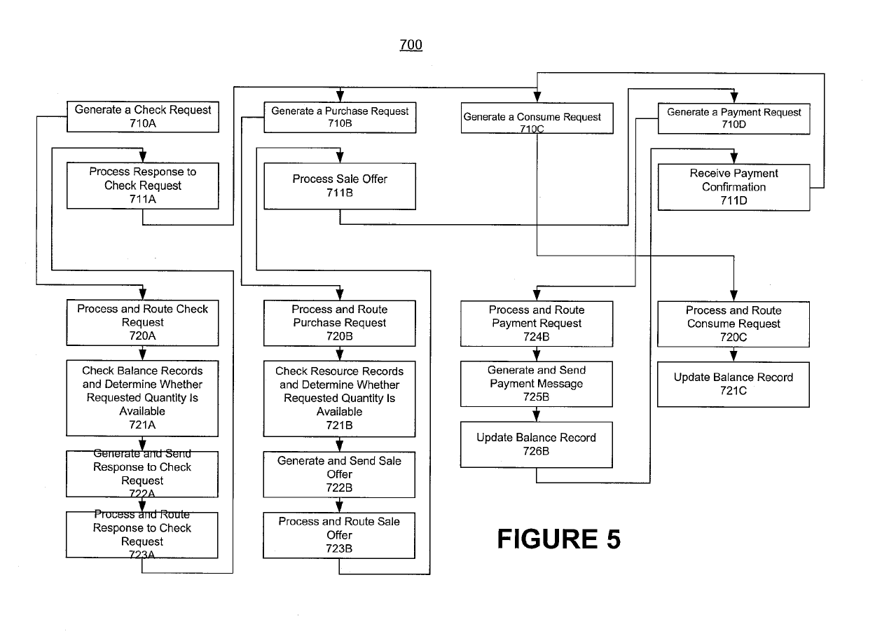

FIG. 5 is a flow diagram illustrating an exemplary method 700. Method 700 can be implemented in some embodiments with components, devices, and techniques as discussed with reference to FIGS. 1-4. In some implementations, one or more steps of method 700 are embodied on a computer readable medium containing computer readable code or machine instructions such that a series of steps are implemented when the computer readable code is executed by a processor. In the following description, various steps of method 700 are described with respect to various components or devices performing the method steps. In some implementations, certain steps of method 700 can be combined, performed simultaneously, or in a different order, without deviating from the objective of method 700 or without producing different results. Method 700 begins generally at a step 710.

An application on a trusted client can generate a resource-related request 710 that is communicated to a service 410 via an API layer 460. In one implementation, the application may be a video game, the trusted client may be a game console 102 (e.g. Xbox®), and the service 410 may be an on-line gaming service (e.g. Xbox® Live®). Thus, according to such an implementation, the video game may be installed on a game console 102 that is in communication with an on-line gaming service 410.

More specifically, the resource-related request 710 can be a check request generated in a step 710A, a purchase request generated in a step 710B, a consume request generated in a step 710C, or a payment request generated in a step 710D. In one implementation, the resource-related request includes a user ID 443, a resource ID 445, and a quantity of the resource ID 445 to be checked, purchased, or consumed. According to one implementation, the resource may be a digital good or service that may be consumed in connection with the application on the trusted client. For example, the consumable resource may be car tires that are consumed in connection with a car-racing video game played on a game console 102. In another example, the consumable resource may be tickets or entries to a virtual video-game tournament played on a game console 102 via an on-line gaming service 410.

A check request generated in a step 710A includes a user ID 443, a resource ID 445, and a quantity of the resource ID 445 to be checked for availability. In a step 711A, the application on the trusted client receives and processes a response from the service 410 to a check request and can, based on the response from the service 410, grant or deny a user identified by user ID 443 access to the requested resource identified by the resource ID 445. If a check request is approved and access to a specified resource ID 445 is granted, the application can generate a consume request in a step 710C, identifying a user ID 443 and a quantity of the resource ID 445 to be consumed. The quantity of the resource ID 445 in the consume request must be equal to or less than the quantity in the granted check request. If a check request is denied and access to a specified resource ID 445 is not granted, the application can generate a purchase request in a step 710B, identifying a user ID 443 and a resource ID 445 of the resource to be purchased.

A purchase request generated in a step 710B includes a user ID 443 and a resource ID 445 to be purchased. In a step 711B, the application on the trusted client receives and processes a sale offer from the service 410 in response to a purchase request and can allow a user identified by user ID 443 to accept the sale offer at a specified price 448 for a specified quantity of the specific resource ID 445. If a sale offer from the service 410 is accepted, the application can generate a payment request in a step 710D, identifying a user ID 443, a quantity of the resource ID 445, and payment method for the price 448 specified in the sale offer. In a step 711D, the application on the trusted client receives a payment confirmation message and can grant a user identified by user ID 443 access to the purchased quantity of the resource identified by the resource ID 445. In a step 710C, the application can generate a consume request, identifying a user ID 443 and a quantity of the resource ID 445 to be consumed.

A service 410 can process many types of requests from a application on a trusted client, including check requests, purchase requests, consume requests, and payment requests. In one implementation, these requests are routed to the service 410 via an API layer comprising a check API module, a purchase API module, and a consume API module.

In a step 720A, the check API module processes a check request and routes the check request to the service 410. In one implementation, the check request identifies a specific user ID 443 and a quantity of a specific resource ID 445. In a step 721A, the service 410 checks its database 440, identifies a balance record 446 associated with the user ID 443 of the request, and determines whether the quantity of the resource ID 445 in the request is available. In one implementation, the user ID 443 is associated with a balance record 446 that includes information regarding the quantity of a resource ID 445 available to the user ID 443. Each balance record 446 can also include history associated with the specific user ID 443 that can incorporate a record of each resource ID 445 accessed, purchased, acquired, or viewed, a tally of purchased electronic payment units, and other information tied to the specific user ID 443. The service 410 may determine that the quantity of the resource ID 445 in the request is or is not available to the user ID 443 based on the balance record 446 associated with the user ID 443. In a step 722A, when a determination is made regarding the quantity of the resource ID 445 in the request, a response is sent to the check API module. If the quantity of the resource ID 445 in the request is determined to be available to the user ID 443, then a response approving the request may be sent. If the quantity of the resource ID 445 in the request is determined not to be available to the user ID 443, then a response denying the request may be sent. In a step 723A, the check API module processes the response from the service 410 and routes the response to the application on the trusted client.

In a step 720B, the purchase API module processes a purchase request and routes the purchase request to the service 410. In one implementation, the purchase request identifies a specific user ID 443 and a specific resource ID 445. In a step 72 1B, the service 410 checks its database 440 and identifies the user record 444 associated with the resource ID 445 identified in the purchase request. The user records 444 may associate each resource ID 445 with an identification code or key (hereinafter simply “application ID 447”) for a specific application and a price 448 for a specified quantity of the resource ID 445. In a step 722B, based on the user record 444, the service 410 generates and sends a sale offer to the purchase API module identifying the user ID 443 and stating the price 448 for a specified quantity of the resource ID 445 identified in the purchase request. The price 448 of the sale offer may be expressed in terms of real or virtual currency. In a step 723B, the purchase API module processes the sale offer from the service 410 and routes the sale offer to the application on the trusted client. In a step 724B, the purchase API receives and processes a payment request from an application on a trusted client in response to a sale offer from the service 410. The payment request includes a user ID 443, a quantity of the resource ID 445, and payment method for the price 448 specified in the sale offer. In a step 725B, after the purchase API module processes the payment request, the purchase API module sends a payment confirmation message to the application on the trusted client and to the service 410 that a sale offer has been accepted and that payment has been received. The payment confirmation message includes a user ID 443 and a quantity of the resource ID 445. In a step 726B, the service 410 checks its database 440 and identifies the balance record 446 associated with the user ID 443 identified in the payment message and adds the quantity of the resource ID 445 specified in the payment message to the quantity of the resource ID 445 in the balance record 446.

In a step 720C, the consume API module processes a consume request and routes the consume request to the service 410. In one implementation, the consume request identifies a specific user ID 443 and a quantity of a specific resource ID 445. In a step 721C, the service 410 checks its database 440 and identifies the balance record 446 associated with the user ID 443 identified in the consume request and deducts the quantity of the resource ID 445 specified in the consume request from the quantity of the resource ID 445 in the balance record 446.

1. A method of managing consumable video-game resources performed by an on-line gaming service, comprising the steps of:
maintaining a list of at least one user ID;
maintaining a list of at least one resource ID, wherein the at least one resource ID is associated with a consumable video-game resource of a video-game application, wherein the consumable video-game resource comprises at least on of a digital good or service that is consumable;
receiving a request associated with one of the at least one user ID for a quantity of at least one of the at least one resource ID; and
determining a balance of the requested resource ID associated with the one user ID; and
determining, in accordance with the balance, if the request can be granted,
wherein the steps are carried out on one or more servers connected to a network.

2. The method of claim 1 further comprising the step of
if it is determined that the request cannot be granted, providing an indication of denial of the request.

3. The method of claim 2 further comprising the steps of:
transmitting a sale offer, wherein the sale offer includes the user ID, a predetermined quantity of the resource ID, and a price;
accepting a payment for the price of the sale offer; and
adding the predetermined quantity of the resource ID to the balance of the resource ID associated with the user ID.

4. The method of claim 1 further comprising the steps of:
if it is determined that the request can be granted, communicating grant of the request; and
subtracting the quantity of the resource ID from the balance of the resource ID associated with the user ID.

5. The method of claim 1 further comprising the step of authenticating the user ID.

6. (canceled)

7. The method of claim 4 wherein the request is received from a video-game application on an electronic device via a check API module, which are connected to the network.

8. The method of claim 4 wherein the lists of the at least one user ID and the at least one resource ID are maintained in one or more databases located on the one or more servers.

9. The method of claim 4 wherein the balance of the resource ID associated with the user ID is maintained in a database located on the one or more servers.

10. A method of managing the consumption of resources, comprising the steps of:
defining at least one resource in an application;
assigning a unique resource ID to each of the at least one resource;
authenticating a user ID;
receiving a selection of a quantity of the at least one resource;
sending a request to check whether the quantity of the resource ID associated with the user ID is available; and
receiving notification regarding the availability of the quantity of the resource ID associated with the user ID,
wherein the steps are performed the application installed on an electronic device that is connected to a network.

11. The method of claim 10 further comprising the steps of
if the quantity of the resource ID is available, granting access to the quantity of the resource;
receiving a request to consume the quantity of the at least one resource; and
transmitting the request to consume the quantity of the one resource ID.

12. The method of claim 10 further comprising the steps of
if the quantity of the resource ID is not available, denying access to the resource;
receiving a request to purchase the resource and transmitting the request to purchase the resource ID;
receiving a sale offer for the resource ID and presenting the sale offer for the resource;
receiving acceptance of the sale offer for the resource and transmitting the acceptance of the sale offer for the resource ID.

13. (canceled)

14. The method of claim 10 wherein the step of sending a request and receiving notification are performed in communication with a database via a check API module, which are connected to the network.

15. The method of claim 11 wherein the step of transmitting the request to consume is performed in communication with a database via a consumption API module, which are connected to the network.

16. The method of claim 12 wherein the steps of transmitting the request to purchase, receiving a sale offer, and of transmitting the acceptance of the sale offer are performed in communication with a database via a purchase API module, which are connected to the network.

17. A system of managing consumable resources comprising:
at least one electronic device connected to a network;
at least one application installed on the electronic device, the application being adapted to authenticate at least one user ID, the application defining at least one resource and assigning a resource ID to the resource;
an API server connected to the network, comprising:
a purchase API module;
a check API module;
a settlement API module; and
a service server connected to the network, comprising a database storing the at least one user ID, the at least one resource ID, a price associated with the at least one resource ID, and a balance of the at least one resource ID associated with the at least one user ID,
wherein the check API module checks the balance of the at least one resource ID associated with the at least one user ID.

18. The system of claim 17 wherein the purchase API module interfaces the application and the service server and adds a specified quantity to the balance of the at least one resource ID associated with the at least one user ID in the database when a purchase of the at least one resource ID is made.

19. The system of claim 17 wherein the check API module interfaces the application and the service server.

20. The system of claim 17 wherein the settlement API module interfaces the application and the service server and subtracts a specified quantity from the balance of the at least one resource ID associated with the at least one user ID in the database when the at least one resource is consumed.
